(19) United States
(12) Patent Application Publication
(10) Pub. No.: US 2026/0177961 A1
(43) Pub. Date: Jun. 25, 2026

(54) IMAGE FORMING APPARATUS, RECOVERY PRINTING METHOD, AND NON-TRASITORY COMPUTER-READABLE RECORDING MEDIUM

(71) Applicant: Konica Minolta, Inc., Tokyo (JP)

(72) Inventor: Taku Sato, Tokyo (JP)

(73) Assignee: Konica Minolta, Inc., Tokyo (JP)

(21) Appl. No.: 19/398,605

(22) Filed: Nov. 24, 2025

(30) Foreign Application Priority Data
Dec. 19, 2024 (JP) 2024-223966

(51) Int. Cl. G03G 15/00

(52) U.S. Cl. CPC G03G 15/5012; G03G 15/5016; G03G 15/5062

(57) ABSTRACT

Provided is an image forming apparatus that includes: an image former; and a hardware processor that controls the image former such that the image former executes recovery processing of resuming image formation processing. The hardware processor controls the image former such that the image former forms identification information, which corresponds to an image position, together with an image on a continuous sheet, and causes the recovery processing to be executed based on the identification information.

### CROSS REFERENCE TO RELATED APPLICATIONS

The entire disclosure of Japanese patent Application No. 2024-223966, filed on Dec. 19, 2024, is incorporated herein by reference in its entirety.

### BACKGROUND

### 1. Technological Field

The present invention relates to an image forming apparatus, a recovery printing method, and a non-transitory computer-readable recording medium.

### 2. Description of the Related Art

In the related art, there is known an image forming apparatus capable of forming an image on a continuous sheet such as roll paper. In an image forming apparatus, in a case where image formation processing is interrupted due to the occurrence of a jam or the like during printing, recovery processing of resuming printing from a page subsequent to a page before the interruption is performed after processing of clearing the jam is performed. At that time, it is necessary to accurately select the page(s) on which the recovery processing is to be performed such that there is no shortage or overlap in the pages printed before and after the interruption.

For example, Japanese Patent Application Laid-Open No. 2016-60088 discloses a configuration in which, in a case where image formation processing is interrupted due to a jam or the like, images for which image formation has been completed are distinguished from images for which image formation has not been completed, and the image formation processing is resumed from an image for which image formation has not been completed. In this configuration, a page from which the image formation processing is resumed is identified based on whether the page has passed through a designated position (for example, a fixer).

### SUMMARY

However, in a case where a jam occurs on the downstream side of the designated position, an image printed in a portion in which the jam has occurred is not printed in the recovery processing in the configuration of Japanese Patent Application Laid-Open No. 2016-60088, and thus, image shortage may occur.

In addition, although it is conceivable that in the most downstream portion of a continuous sheet, the recovery processing is performed from a page, on which the winding has been completed, or a subsequent page thereof, a page(s), on which printing has been performed, in the portion in which the jam has occurred also become(s) a target of the recovery processing, and page overlapping occurs. That is, in the configuration in which image formation is performed on a continuous sheet, the page(s) on which the recovery processing is performed varies/vary depending on the position at which a jam occurs, and thus, a configuration in which the position at which the recovery processing is performed is accurately selected is desired.

An object of the present invention is to provide an image forming apparatus, a recovery printing method, and a non-transitory computer-readable recording medium each capable of performing, at an accurate position, recovery processing after image formation processing is interrupted in continuous sheet printing.

In order to achieve at least one of the above-described objects, an image forming apparatus reflecting one aspect of the present invention includes:
an image former that forms an image on a continuous sheet to be conveyed; and
a hardware processor that controls the image former such that the image former executes, after image formation processing by the image former is interrupted, recovery processing of resuming the image formation processing.

The hardware processor controls the image former such that the image former forms identification information, which corresponds to an image position formed on the continuous sheet, together with the image on the continuous sheet, and
the hardware processor causes the recovery processing to be executed based on the identification information.

In order to achieve at least one of the above-described objects, a recovery printing method reflecting one aspect of the present invention is a recovery printing method by an image forming apparatus including an image former that forms an image on a continuous sheet to be conveyed, and the recovery printing method includes:
controlling the image former such that the image former forms identification information, which corresponds to an image position formed on the continuous sheet, together with the image on the continuous sheet, and
controlling the image former such that the image former executes, after image formation processing by the image former is interrupted, recovery processing of resuming the image formation processing based on the identification information.

In order to realize at least one of the above-described objects, a non-transitory computer-readable recording medium reflecting one aspect of the present invention is a non-transitory computer-readable recording medium storing a recovery printing program to be executed by an image forming apparatus, which includes an image former that forms an image on a continuous sheet to be conveyed. The recovery printing program causes a computer to execute:
controlling the image former such that the image former forms identification information, which corresponds to an image position formed on the continuous sheet, together with the image on the continuous sheet, and
controlling the image former such that the image former executes, after image formation processing by the image former is interrupted, recovery processing of resuming the image formation processing based on the identification information.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an overall configuration of an image forming system including an image forming apparatus according to an embodiment of the present invention;

FIG. 2 is a diagram illustrating an example of printing on a continuous sheet;

FIG. 3 is a diagram illustrating an example of the continuous sheet in which a jam has occurred;

FIG. 4 is a diagram illustrating an example of the continuous sheet after jam processing;

FIG. 5 is a diagram illustrating an example of image formation in recovery processing;

FIG. 6 is a diagram illustrating an example of the continuous sheet after the jam processing;

FIG. 7 is a diagram illustrating an example of the image formation in the recovery processing;

FIG. 8 is a flowchart illustrating exemplary operations of image formation control at the image forming apparatus;

FIG. 9 is a diagram illustrating a display example of the setting of identification information;

FIG. 10 is a diagram illustrating a display example of the setting of the identification information;

FIG. 11 is a diagram illustrating a display example of the settings of types of the identification information; and

FIG. 12 is a diagram illustrating an example of printing on a continuous sheet.

### DETAILED DESCRIPTION OF EMBODIMENTS

Hereinafter, one or more embodiments of the present invention will be described with reference to the drawings. However, the scope of the invention is not limited to the disclosed embodiments.

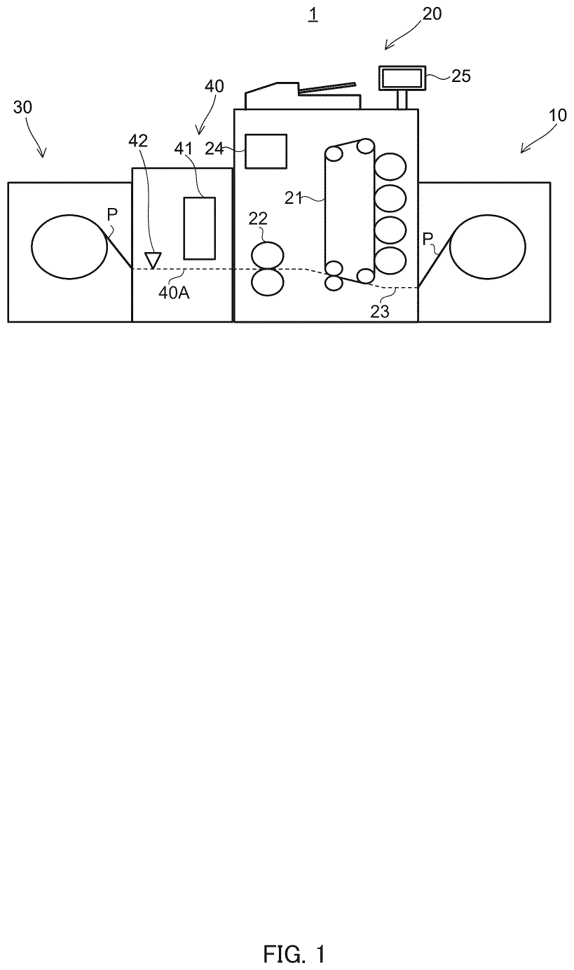

Hereinafter, an embodiment of the present invention will be described in detail with reference to the accompanying drawings. FIG. 1 is a diagram schematically illustrating an overall configuration of an image forming system 1 including an image forming apparatus 20 according to an embodiment of the present invention.

As illustrated in FIG. 1, the image forming system 1 is a system that forms an image on a recording medium (a recording medium including a continuous sheet P indicated by the thick line in FIG. 1 or the like). Here, the continuous sheet P is a continuous medium having, for example, a length exceeding the width of a main body of the image forming apparatus 20 in the conveyance direction of the continuous medium, and is, for example, roll paper. The image forming system 1 includes a sheet feed apparatus 10, the image forming apparatus 20, a winding apparatus 30, and an image reading apparatus 40.

The sheet feed apparatus 10 is an apparatus that feeds the continuous sheet P to the image forming apparatus 20. In the housing of the sheet feed apparatus 10, the continuous sheet P is held in a state of being wound around a support shaft in a roll shape. The sheet feed apparatus 10 feeds the continuous sheet P wound around the support shaft to the image forming apparatus 20 at a constant speed via, for example, a plurality of conveyance roller pairs such as a feeding-out roller and a sheet feed roller. The sheet feed operation of the sheet feed apparatus 10 is controlled by a controller 24 included in the image forming apparatus 20.

The image forming apparatus 20 is, for example, a color image forming apparatus of an intermediate transfer method utilizing an electrophotographic process technology. Specifically, the image forming apparatus 20 primary-transfers toner images of colors of yellow (Y), magenta (M), cyan (C), and black (K) formed on photosensitive drums onto an intermediate transfer belt, superimposes the toner images of the four colors on one another on the intermediate transfer belt, and then secondary-transfers the resultant image onto a recording medium fed out from sheet feed tray units to form an image. Note that, the image forming apparatus 20 may be an image forming apparatus other than that of the intermediate transfer method.

The image forming apparatus 20 includes an image former 21, a fixer 22, a conveyor 23, the controller 24, and the like.

The controller 24 includes a central processing unit (CPU), a read only memory (ROM), a random access memory (RAM), and the like. The CPU reads a program according to the processing content from the ROM, develops the program in the RAM, and performs centralized control of the operation of each block and the like of the image forming apparatus 20 in cooperation with the developed program.

The image former 21 forms an image (toner image) on a recording medium fed from the sheet feed apparatus 10. The image former 21 includes image forming units for forming images with color toners of Y, M, C, and K components, an intermediate transfer unit, and the like.

The fixer 22 heats and pressurizes the conveyed recording medium, onto which the toner image has been transferred, at a fixing nip, thereby fixing the toner image on the recording medium.

The conveyor 23 includes a conveyance route, a sheet ejector, and the like. The conveyance route includes a plurality of conveyance roller pairs, a normal conveyance path along which the recording medium is passed through the image former 21 and the fixer 22 and is ejected to the outside of the image forming apparatus 20, and the like. Note that, illustration of the continuous sheet P that is conveyed on the conveyor 23 is omitted in FIG. 1.

In addition, the image forming apparatus 20 is provided with an operation display 25. The operation display 25 includes an operator, which is operable by the user, and a display, on which settings of the image forming apparatus 20 can be performed. By operating the operation display 25, the user can perform settings of the image forming apparatus 20. In addition, for example, instruction information or the like, which will be described later, is displayed on the operation display 25, which allows the user to perform work such as jam processing.

The continuous sheet P fed from the sheet feed apparatus 10 to the image forming apparatus 20 is conveyed to the image former 21 by the conveyor 23. Then, at the image former 21, toner images on the image forming units and the intermediate transfer unit are collectively secondarily-transferred onto one surface of the continuous sheet P, and a fixing process is performed thereon at the fixer 22.

The continuous sheet P on which an image has been formed is conveyed to the winding apparatus 30 via the image reading apparatus 40 by the conveyor 23.

The winding apparatus 30 is an apparatus that winds up the continuous sheet P that has been conveyed from the image forming apparatus 20. In the housing of the winding apparatus 30, for example, the continuous sheet P is wound around a winding shaft and held in a roll shape. For this reason, the winding apparatus 30 winds up the continuous sheet P, which has been conveyed from the image forming apparatus 20, around the winding shaft at a constant speed. The winding-up operation of the winding apparatus 30 is controlled by the controller 24 included in the image forming apparatus 20.

The image reading apparatus 40 is an apparatus for reading an image formed on a recording medium conveyed from the image forming apparatus 20, and is provided between the image forming apparatus 20 and the winding apparatus 30. The image reading apparatus 40 is provided with a conveyance route 40A connected to a sheet ejection port of the image forming apparatus 20. A reader 41 and a jam detection sensor 42 are provided in the conveyance route 40A. Note that, illustration of the continuous sheet P that is conveyed on the conveyance route 40A is omitted is FIG. 1.

The reader 41 is formed of, for example, an in-line sensor in which an optical sensor, a colorimeter, and the like are arranged in a direction orthogonal to the conveyance direction of the continuous sheet P. The reader 41 reads, for example, an adjustment chart or the like formed on the continuous sheet P, and feeds back the read image information to the image forming apparatus 20 via a communicator (not illustrated).

Thus, the controller 24 of the image forming apparatus 20 performs image correction on the image formation condition(s) at the image former 21 according to the read information of the recording medium. The method of the image correction may be, for example, a technique known in the art.

The jam detection sensor 42 is a sensor known in the art capable of detecting a jam of the continuous sheet P, and is provided, for example, on the downstream side of the reader 41 in the conveyance route 40A. For example, in a case where in a damaged portion such as a break or a wrinkle occurs in the continuous sheet P, the jam detection sensor 42 detects the damaged portion. Note that, the jam detection sensor 42 may also be provided in the sheet feed apparatus 10, the image forming apparatus 20, and the winding apparatus 30.

Jam information detected by the jam detection sensor 42 is transmitted to the image forming apparatus 20 via a communicator (not illustrated). In a case where the controller 24 acquires the jam information, the controller 24 interrupts the image formation processing on the continuous sheet P. The controller 24 notifies the user to perform jam processing, for example, via a notification medium such as the operation display 25 provided in the image forming apparatus 20.

The jam processing is processing for clearing a jam, and is, for example, processing for removing a portion of a jam factor (the damaged portion described above) in the continuous sheet P and joining the portions before and after the removed portion to each other. The jam processing is manually performed by the user. In the jam processing, a range of the continuous sheet P from a position at which a jam has occurred (the position of the jam detection sensor 42) to a position at which an image has been formed by the image former 21 is removed.

The controller 24 controls the image former 21 such that the image former 21 executes, after a jam has been cleared by the processing for clearing the jam, recovery processing of resuming the image formation processing.

The recovery processing is processing for resuming the image formation processing after the interruption of the image formation processing, and includes, for example, processing of reprinting an image formed on a portion removed by the jam processing. In the recovery processing, images from an image at a position at which a jam has occurred (the position at which the jam has been detected), that is, a position that serves as the interruption factor of the image formation processing, to an image at a position at which an image has been formed by the image former 21 at the time point when the jam has been detected are reprinted.

For this reason, when the recovery processing is executed, it is necessary to accurately select the start position of the recovery processing. In the present embodiment, identification information is formed on the continuous sheet P in order to identify the start position of the recovery processing.

Specifically, the controller 24 controls the image former 21 such that the image former 21 forms, together with an image, identification information corresponding to an image position that is formed on the continuous sheet P.

The identification information is information for identifying an image that is formed at each position in the conveyance direction of the continuous sheet P, and the identification information includes, for example, information on a page number indicating the page of an image.

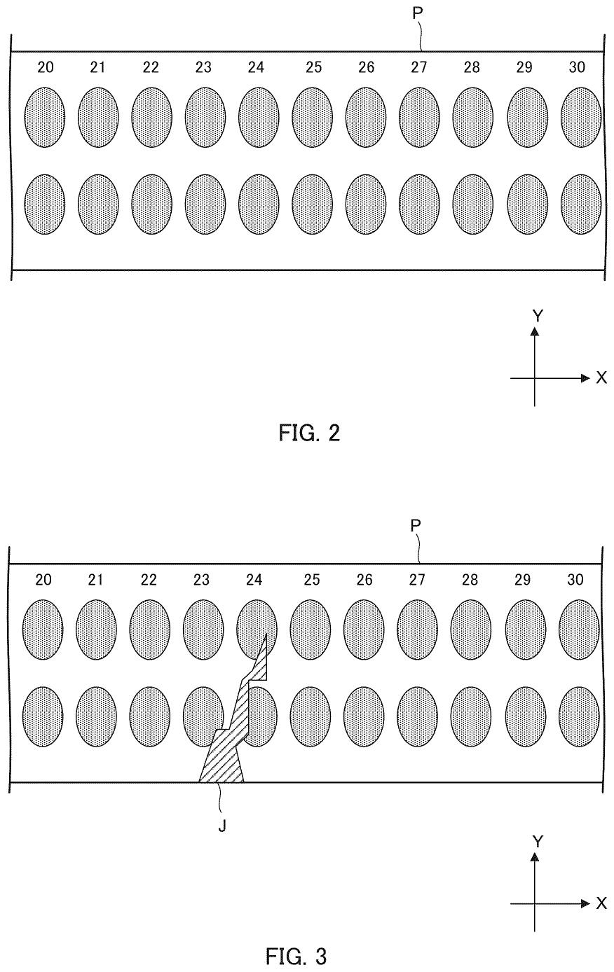

For example, an example in which images are arranged in the page order on the continuous sheet P extending in the conveyance direction (the X direction) is illustrated as in FIG. 2. In the example illustrated in FIG. 2, two images are arranged side by side in the width direction (the Y direction) of the continuous sheet P in a region for one page.

In this case, for example, the numbers (20 to 30 in FIG. 2) indicating the page numbers are formed as the identification information at positions on the + side in the Y direction of the respective images. In this way, it is possible to easily associate each image position with the identification information. Note that, on the continuous sheet P, the portion in which the identification information is formed is, for example, a margin region in an end portion on the + side or the − side in the Y direction of the continuous sheet P.

Here, for example, as illustrated in FIG. 3, it is assumed that a jam J has occurred in a portion corresponding to pages 23 and 24 of the continuous sheet P. In this case, it is assumed that the portion corresponding to the pages 23 and 24 is located in the vicinity of the jam detection sensor 42 and images have been formed up to the portion of a page 30.

In this case, for example, a range including at least the pages 23 and 24 is designated by a setting operation of the user as a portion that is removed by the jam processing. The portion that is removed by the jam processing is a range that varies depending on the type of printing.

For example, in a case where the image formation processing is processing of sequentially forming different images on the continuous sheet P (variable printing), the images need to be arranged in the page order. For this reason, in this case, a range from a position designated by the user to a position at which the image formation has last been performed after a range that serves as the interruption factor is a portion that is removed by the jam processing.

For example, as illustrated in FIG. 3, it is assumed that the first image in the range in which the jam has occurred is the image of the page 23, and the position at which the image formation has last been performed after the range that serves as the interruption factor is the page 30. In the example of FIG. 3, the range from a page 22, which is the page preceding the pages that serve as the jam factor, to the page 30 is the range designated by the user.

In this case, the image forming apparatus 20 is notified of guidance so as to remove the entire range (the range from the page 22 to the page 30 in FIG. 3) of the pages, which are the jam portion, and the following pages on which images have already been formed. The guidance may be, for example, information indicating to the effect that “the jam portion and all the following printed portions are removed”. That is, the controller 24 outputs instruction information for removing a range of the continuous sheet P, where the range is related to the interruption factor of the image formation processing, and a region of the continuous sheet P after the range, where image formation has already been performed in the region. This instruction information may be character information or sound information. In a case where the instruction information is character information, the character information is displayed on, for example, the operation display 25 of the image forming apparatus 20.

Outputting such instruction information makes it easier for the user to perform the jam processing.

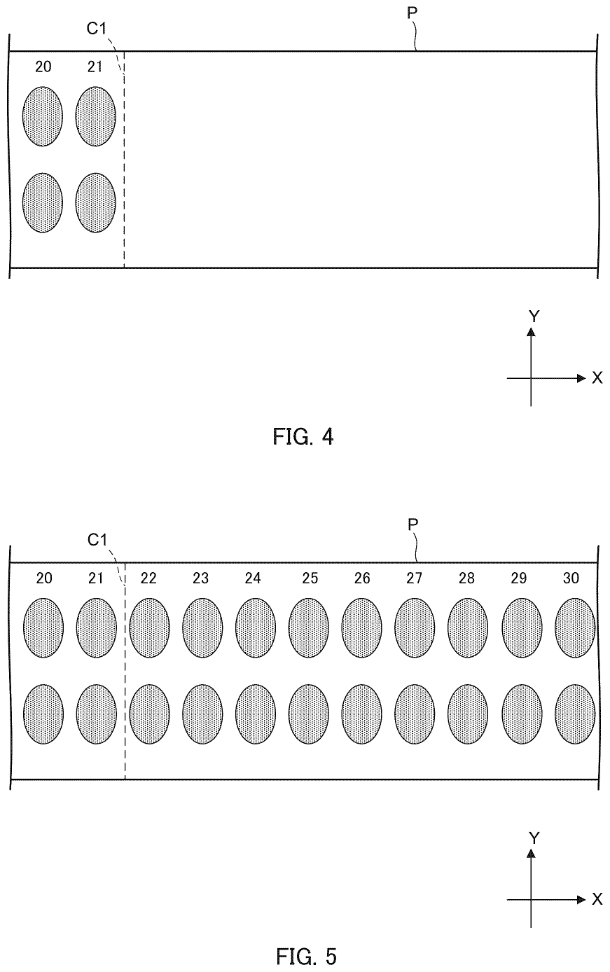

As illustrated in FIG. 4, the continuous sheet P after the jam processing is in a state in which the range, which includes the page 22 and the subsequent pages and in which the image formation had been performed, has been removed and the portions before and after the range have been joined to each other. In FIG. 4, C1 is a joint portion of the continuous sheet P.

Then, the controller 24 causes the recovery processing to be executed based on the identification information after the jam processing by the user. In the case of FIG. 4, the page 22 and the subsequent pages have been removed, and thus, the controller 24 resumes the image formation from the image corresponding to the page 22. In this case, together with the image of the page 22, the information of the number 22 is formed as the identification information, and the identification information is also formed for the images of the pages following the page 22 in the same manner.

In this way, as illustrated in FIG. 5, the images of the page 22 and the subsequent pages are formed after C1 of the joint on the continuous sheet P.

That is, in the case of variable printing, the controller 24 controls the image former 21 such that the image former 21 forms, at the position of the image formation start of the recovery processing on the continuous sheet P, the identification information corresponding to the position related to the interruption factor of the image formation processing.

In addition, in a case where the image formation processing is processing of repeatedly forming an identical image on the continuous sheet P (repeat printing), an image(s) that is/are removed by the jam processing is identical to an image(s) that has/have not been removed, and thus, it is considered that it is not necessary to remove the continuous sheet P more than necessary.

For this reason, in this case, a range related to the interruption factor and a range in which an image(s) has/have already been formed but which has not passed through the fixer 22 are designated by a setting operation of the user as portions that are removed by the jam processing.

For example, in the example illustrated in FIG. 3, the range in which the jam has occurred is the pages 23 and 24, and thus, the range from the page 22 to a page 25, in which the page before the page 23 and the page after the page 24 are added to the pages 23 and 24, is the range designated by the user. In addition, the range in which an image(s) has/have already been formed but which has not passed through the fixer 22 is, for example, pages 29 and 30.

Note that, in the case of repeat printing, the above-described guidance may not be performed.

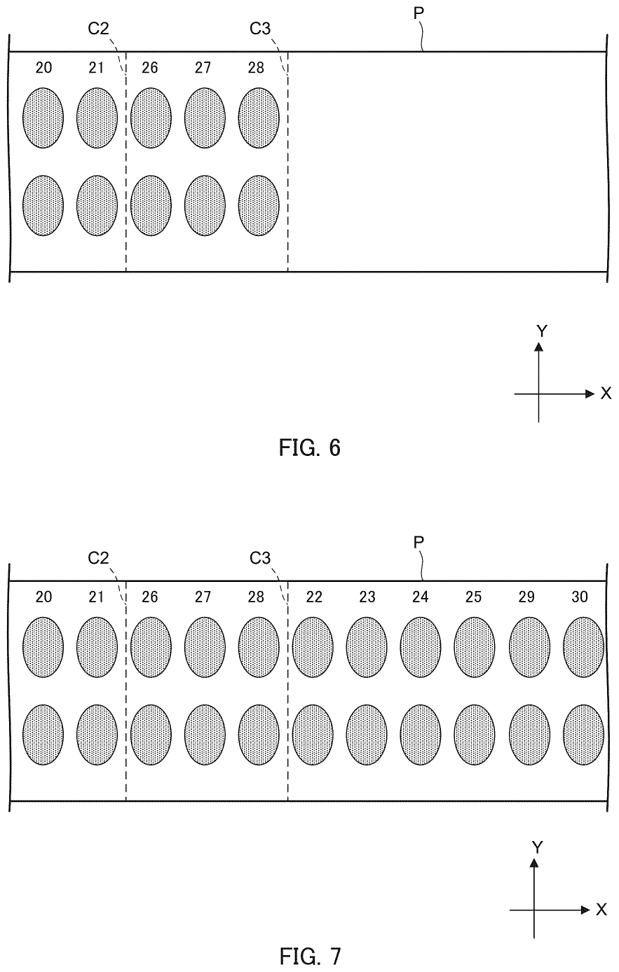

In the continuous sheet P after the jam processing in this case, the range from the page 22 to the page 25 as well as the pages 29 and 30 have been removed, and the leading end of the portion of the range from a page 26 to a page 28 is joined to the portion of the range up to the page 21 (see C2) as illustrated in FIG. 6. Then, the rear end of the portion of the range from the page 26 to the page 28 and the portion after the page 30 are joined to each other (see C3). In FIGS. 6, C2 and C3 are joint portions of the continuous sheet P.

Then, the controller 24 causes the recovery processing to be executed based on the identification information after the jam processing by the user. In the case of FIG. 6, the range from the page 22 to the page 25 as well as the pages 29 and 30 have been removed, and thus, the pages ranging from the page 26 to the page 28 are located after the page 21 in the state before the recovery processing. For this reason, after the page 28, information on the numbers 22 to 25, 29, and 30 is formed together with the respective images of the pages 22 to 25 and the pages 29 and 30 as identification information as illustrated in FIG. 7.

That is, in the case of the repeat printing, the controller 24 controls the image former 21 such that the image former 21 sequentially forms, from the position of the image formation start of the recovery processing on the continuous sheet P, the identification information corresponding to an image that has been removed from the continuous sheet P.

Note that, the identification information corresponding to the portion that is removed by the jam processing may be other than the information designated by the user, for example, may be recognized by a reader. In other words, the controller 24 may determine the identification information of the start position of the recovery processing based on the reading result of the reader. In addition, the reader for reading the identification information may be provided separately from the reader 41. This reader is provided at an arbitrary position on the downstream side of the fixer 22, for example, in the winding apparatus 30 or the like.

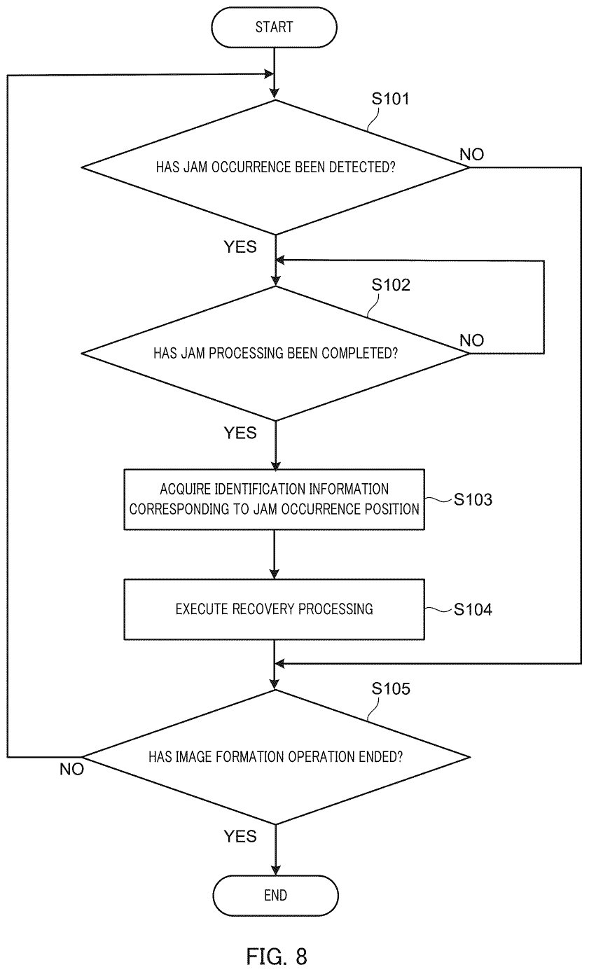

Exemplary operations of image formation control at the image forming apparatus 20 configured as described above will be described. FIG. 8 is a flowchart illustrating exemplary operations of image formation control at the image forming apparatus 20. This control is appropriately executed when the controller 24 has received an instruction to execute a job of image formation processing on the continuous sheet P.

As illustrated in FIG. 8, the controller 24 determines whether the jam detection sensor 42 has detected the occurrence of a jam (step S101). As a result of the determination, in a case where no jam occurrence has been detected (step S101, NO), the processing proceeds to step S105.

On the other hand, in a case where a jam occurrence has been detected (step S101, YES), the controller 24 interrupts the image formation processing and determines whether the jam processing by the user has been completed (step S102).

As a result of the determination, in a case where the jam processing has not been completed (step S102, NO), the processing in step S102 is repeated. On the other hand, in a case where the jam processing has been completed (step S102, YES), the controller 24 acquires identification information corresponding to the jam occurrence position (step S103). The identification information corresponding to the jam occurrence position is information designated by the user. Note that, processing of notifying the user of the jam occurrence may also be executed between steps S102 and S103.

After step S103, the controller 24 causes the recovery processing to be executed (step S104).

After step S104, the controller 24 determines whether the image formation processing has ended (step S105).

As a result of the determination, in a case where the image formation processing has not ended (step S105, NO), the processing returns to step S101. On the other hand, in a case where the image formation processing has ended (step S105, YES), the present control ends.

According to the present embodiment configured as described above, identification information corresponding to an image position is formed together with an image on a continuous sheet, and the recovery processing is executed based on the identification information. As a result, the recovery processing after the image formation processing is interrupted in continuous sheet printing can be performed at an accurate position.

Thus, it is possible to suppress shortage of images and overlapping of images in the recovery processing.

Next, a method of setting identification information by a designation by the user will be described.

In the present embodiment, the user can set, based on instruction information, a page(s), which has/have been removed by the jam processing, via the operation display 25. That is, the operation display 25 sets the identification information of the start position of the recovery processing based on a designation by the user.

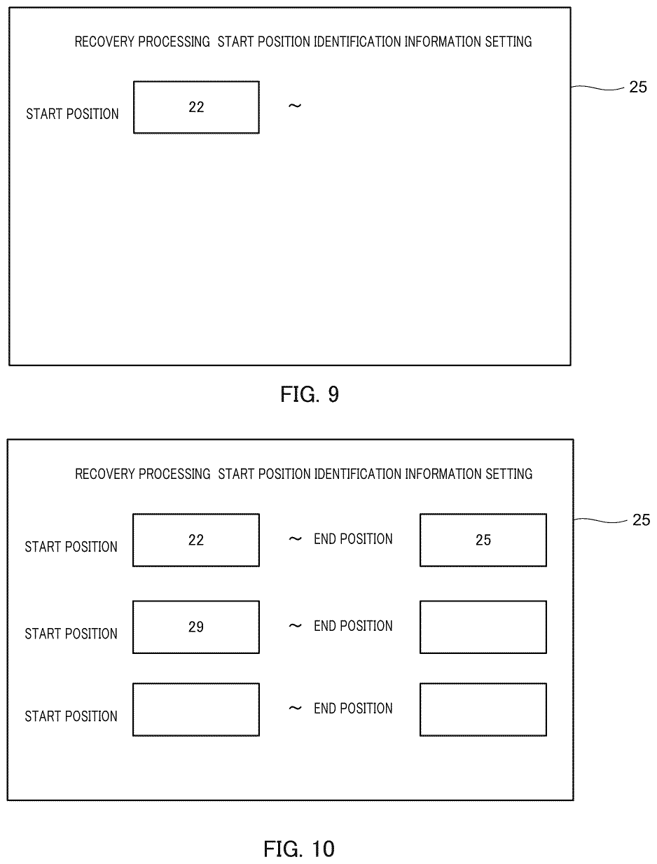

For example, in the case of variable printing, it may be configured such that only a setting portion of the start position of the recovery processing is displayed on the operation display 25 and the user is allowed to input a number to the setting portion as illustrated in FIG. 9.

In addition, in the case of repeat printing, the portion removed by the jam processing is divided into a plurality of ranges, and thus, it may be configured such that setting portions of the plurality of ranges are displayed on the operation display 25 and the user is allowed to input numbers to the setting portions of the respective ranges as illustrated in FIG. 10. In addition, in the case of repeat printing, the images of the respective pages are identical, and thus, it may be configured such that the total value of the number of removed pages is input and set.

In addition, although the identification information is information on a page number in the above embodiment, the present invention is not limited thereto. For example, the identification information may be information on an image number. For example, in a case where two or more images are arranged in the X direction in a space for one page, the information on the image number is information on numbers that are assigned to the images at different positions in the X direction, respectively.

In addition, the identification information may be information on a printing distance. The information on the printing distance is information on a distance that is attached each time printing is performed on the continuous sheet P for a predetermined distance (for example, 1 m). For example, it is assumed that printing with a total printing length of 4 m has been performed, and that an interruption factor has occurred in a range from 2 m to 3 m. In this case, in the case of repeat printing, a range from a position, to which the distance information of 2 m has been attached, to a position, to which the distance information of 3 m has been attached, is a jam processing target region and is a range in which reprinting is performed in the recovery processing. In addition, in the case of variable printing, the entire remaining range from a position to which the distance information of 2 m has been attached (the entire range is a range to which each of the distance information of 3 m and the distance information of 4 m has been attached) is a range in which reprinting is performed in the recovery processing.

In addition, the type of the identification information can be designated by the user. That is, the controller 24 may set the identification information based on a designation by the user via the operation display 25.

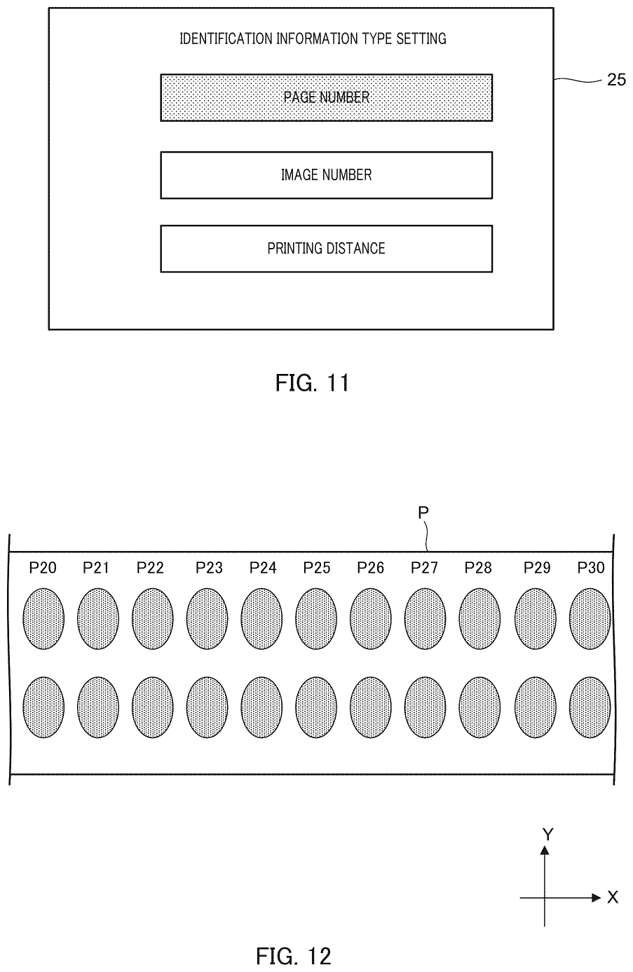

For example, as illustrated in FIG. 11, a plurality of types of identification information is displayed on the operation display 25, and the user designates one of the displayed plurality of types of identification information, whereby the designated identification information is set. The plurality of types of identification information includes each information on the page number, the image number, and the printing distance described above. In addition, the plurality of types of identification information may also include information other than the page number, the image number, and the printing distance as long as the position(s) of an image(s) can be identified. In the example illustrated in FIG. 11, the page number has been set as the identification information.

In addition, in the above-described embodiment, only the number(s) that indicate(s) the page number(s) or the like indicating the identification information have been formed on the continuous sheet P. However, the present invention is not limited thereto, and other information may be formed on the continuous sheet P in addition to the identification information.

Specifically, the controller 24 may add information indicating the type of the identification information, in addition to the identification information. For example, FIG. 12 exemplifies information in which the letter “P” indicating the page is added to the numbers indicating the page numbers. In addition, an example of the character to be added to the image number is, for example, “I”, and an example of the character to be added to the printing distance is, for example, “cm”.

In addition, any of the embodiment described above is only illustration of an exemplary embodiment for carrying out the present invention, and the technical scope of the present invention shall not be construed limitedly thereby. That is, the present invention can be carried out in various forms without departing from the gist or the main features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus, comprising:
an image former that forms an image on a continuous sheet to be conveyed; and
a hardware processor that controls the image former such that the image former executes, after image formation processing by the image former is interrupted, recovery processing of resuming the image formation processing, wherein:
the hardware processor controls the image former such that the image former forms identification information together with the image on the continuous sheet, the identification information corresponding to an image position formed on the continuous sheet, and
the hardware processor causes the recovery processing to be executed based on the identification information.

2. The image forming apparatus according to claim 1, wherein
the identification information includes information on a page number.

3. The image forming apparatus according to claim 1, wherein
the identification information includes information on an image number.

4. The image forming apparatus according to claim 1, wherein
the identification information includes information on a printing distance.

5. The image forming apparatus according to claim 1, wherein
the hardware processor sets the identification information based on a designation by a user.

6. The image forming apparatus according to claim 1, wherein
the hardware processor adds information indicating a type of the identification information, in addition to the identification information.

7. The image forming apparatus according to claim 1, wherein
in a case where the image formation processing is processing of sequentially forming different images on the continuous sheet, the hardware processor controls the image former such that the image former forms, at a position of an image formation start of the recovery processing on the continuous sheet, the identification information corresponding to a position related to an interruption factor of the image formation processing.

8. The image forming apparatus according to claim 7, wherein
the hardware processor outputs instruction information for removing a range of the continuous sheet and a region of the continuous sheet after the range, the range being related to the interruption factor of the image formation processing, the region being a region in which image formation has already been performed.

9. The image forming apparatus according to claim 1, wherein
in a case where the image formation processing is processing of repeatedly forming an identical image on the continuous sheet, the hardware processor controls the image former such that the image former sequentially forms, from a position of an image formation start of the recovery processing on the continuous sheet, the identification information corresponding to an image that has been removed from the continuous sheet.

10. The image forming apparatus according to claim 1, wherein
the hardware processor sets the identification information of a start position of the recovery processing based on a designation by a user.

11. The image forming apparatus according to claim 1, further comprising an identification reader capable of reading the identification information, wherein
the hardware processor determines the identification information of a start position of the recovery processing based on a reading result of the identification reader.

12. A recovery printing method by an image forming apparatus including an image former that forms an image on a continuous sheet to be conveyed, the recovery printing method comprising:
controlling the image former such that the image former forms identification information together with the image on the continuous sheet, the identification information corresponding to an image position formed on the continuous sheet, and
controlling the image former such that the image former executes, after image formation processing by the image former is interrupted, recovery processing of resuming the image formation processing based on the identification information.

13. A non-transitory computer-readable recording medium storing a recovery printing program to be executed by an image forming apparatus, the image forming apparatus including an image former that forms an image on a continuous sheet to be conveyed, the recovery printing program causing a computer to execute:
controlling the image former such that the image former forms identification information together with the image on the continuous sheet, the identification information corresponding to an image position formed on the continuous sheet, and
controlling the image former such that the image former executes, after image formation processing by the image former is interrupted, recovery processing of resuming the image formation processing based on the identification information.
